(19) United States
(12) Patent Application Publication
(10) Pub. No.: US 2013/0200823 A1
(43) Pub. Date: Aug. 8, 2013

(54) MOTOR FOR HAIR GROOMING APPARATUS

(71) Applicant: Hon Hung Joseph Chan, Hong Kong (CN)

(72) Inventor: Hon Hung Joseph Chan, Hong Kong (CN)

(73) Assignee: Conair Corporation, Stamford, CT (US)

(21) Appl. No.: 13/364,820

(22) Filed: Feb. 2, 2012

(51) Int. Cl. H02K 7/14; H02P 31/00; H02K 33/16

(52) U.S. Cl. 318/3; 310/36; 318/129

(57) ABSTRACT

A motor is provided which includes a pivotable portion having a permanent magnet mounted thereto, and first and second lamination arms, wherein the magnet induces positive and negative polarities in the first and second lamination arms, respectively. The motor further includes a fixed portion including an “E” shaped lamination having three lamination arms and a coil wound about one of the three lamination arms. When a current flowing in a first direction is applied to the coil, a first magnetic field is induced that affects polarity of at least on of the three lamination arms and thus generates a force that causes the first portion to pivot in a first direction. When the current flows in a second direction, a second magnetic field is induced that affects polarity of at least one of the three lamination arms and causes the first portion to pivot in a second direction.

### BACKGROUND

The present disclosure relates generally to a motor for providing vibrational, reciprocating, or oscillatory motion. In particular, the present disclosure relates to a motor and control thereof for operating an oscillating pivot head of the hair grooming apparatus.

There are a variety of electrical devices having motors for providing vibrational, reciprocating, or oscillatory motion, such as hair clippers, hair trimmers, shavers, massagers, and the like. Hair clippers typically include a stationary hair cutting blade and a reciprocating hair cutting blade that is oscillated relative to and cooperates with the stationary blade to cut hair. Desirable clipper features include speed and strong cutting power.

### SUMMARY

The present disclosure is directed to a motor for providing reciprocating motion. The motor includes a pivotal portion pivotable about a rotation axis and having a permanent magnet mounted thereto. The pivotal portion further includes first and second lamination arms each having a proximal end, wherein the magnet induces positive and negative polarities in the first and second lamination arms, respectively.

The motor further includes a fixed portion having an “E” shaped lamination which includes third, fourth, and fifth lamination arms, each having a distal end. The proximal ends of the first and second lamination arms proximately face at least one of the distal ends of the third, fourth and fifth lamination arms. The motor also includes a coil having at least one turn wound about the fifth lamination arm. When a current flowing in a first direction is applied to the coil, a first magnetic field is induced that affects polarity of at least one of the third, fourth and fifth lamination arms and thus generates a force that causes the first portion to pivot in a first direction. When a current flowing in a second direction opposite to the first direction is applied to the coil, a second magnetic field is induced that affects polarity of at least one of the third, fourth and fifth lamination arms and thus generates a different force that causes the first portion to pivot in a second direction.

The present disclosure is also directed to a circuit for driving a motor for providing an oscillating motion of a pivot head in a hair grooming device, the circuit comprising a controller for controlling the circuit to output a PWM signal having a frequency that ranges between 125 Hz-200 Hz.

Other features of the presently disclosed motor and electrical circuit will become apparent from the following detailed description, taken in conjunction with the accompanying drawings, which illustrate, by way of example, the presently disclosed motor and electrical circuit.

### BRIEF DESCRIPTION OF THE DRAWINGS

Various embodiments of the present disclosure will be described below with reference to the figures, wherein:

FIG. 1 is a top perspective view of a clipper, in accordance with the present disclosure;

FIG. 2 is a top-perspective view of the clipper shown in FIG. 1, with a top portion of the housing phantomized;

FIG. 3 is an exploded view of a motor of the clipper in accordance with the present disclosure;

FIG. 4A is a top view of the motor of the clipper shown in FIG. 2;

FIG. 4B is a side view of the motor of the clipper shown in FIG. 2;

FIG. 4C is a bottom view of the motor of the clipper shown in FIG. 2;

FIG. 4D is a front view of the motor of the clipper shown in FIG. 2;

FIG. 4E is a back view of the motor of the clipper shown in FIG. 2;

FIG. 5A is a top view of the motor of the clipper shown in FIG. 2 without the bracket, and with the motor shown in a rest position;

FIG. 5B is a top view of the motor shown in FIG. 5A with the motor shown in a first pivoted position;

FIG. 5C is a top view of the motor shown in FIG. 5A with the motor shown in a second pivoted position;

FIG. 6 is a block diagram of a circuit that generates a PWM signal that is applied to the motor shown in FIG. 5A;

FIG. 7 is a schematic electrical circuit diagram of the circuit shown in FIG. 6;

FIG. 8 is a displayed measurement of pulses output by a MOSFET of the electrical circuit shown in FIG. 7;

FIG. 9 is a displayed measurement of pulses output by another MOSFET of the electrical circuit shown in FIG. 7;

FIG. 10 is a displayed measurement of pulses generated by the circuit shown in FIG. 7 that will be input to terminals of the motor shown in FIG. 5A; and

FIG. 11 is a displayed measurement of pulses generated by the circuit shown in FIG. 7 while provided as input to terminal of the motor shown in FIG. A.

### DETAILED DESCRIPTION

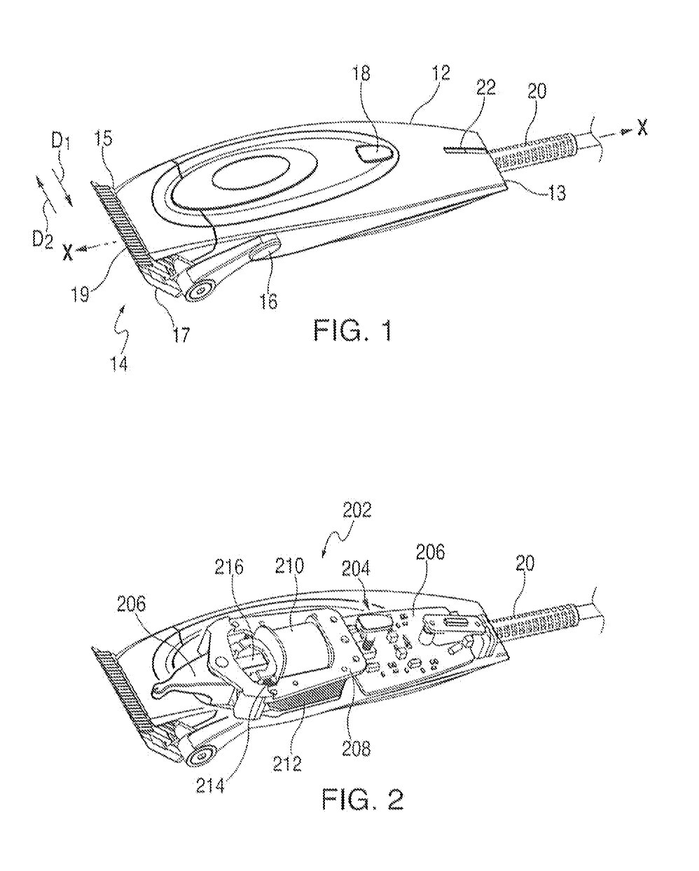

Referring now to the drawing figures, in which like reference numerals identify identical or corresponding elements, the motor and motor control circuit for operating a pivot head of a hair groom apparatus in accordance with the present disclosure will now be described in detail. With initial reference to FIGS. 1 and 2, an exemplary hair grooming apparatus in accordance with the present disclosure is illustrated and is designated generally as grooming apparatus 100. The grooming apparatus is shown in the present example as a clipper, however the disclosure is not limited thereto. The present disclosure encompasses other apparatus' that drive a pivoting head to pivot to and fro in an oscillating fashion.

The terms “hair grooming apparatus” as used herein encompasses any electromechanical apparatus or system for grooming hair or fur, including, for example, shaving, cutting, trimming, blowing, combing, brushing, tweezing, clipping, and epilating hair.

Clipper 10 includes a housing 12 extending along a longitudinal axis X-X and having a proximal end 13 configured to be grasped or held by a user. The housing has a distal end 15 that can be provided with a grooming attachment 14, such as shaver blade set, clipper blade set, or trimmer blade set. The attachment 14 may be permanently or removably mounted to housing 12. An attachment mechanism 16 may be provided for controlling or adjusting mounting, positioning, and/or releasing of the attachment 14. The attachment 14 may include a stationary blade 17 and a reciprocating blade 19 that oscillates between two directions D1 and D2 while cooperating with the stationary blade 17 for cutting hair.

An activator 18, e.g., a user operated switch, is provided that controls activation of motor 202 disposed within housing 12. In the exemplary embodiment shown, an electrical conductor 20 is provided that couples between a power source (not shown) and an electrical circuit 204, e.g., provided on a printed circuit board assembly (PCBA) 206, disposed within housing 12. In the embodiment shown, the electrical conductor includes an electrical cord that plugs into the power source, e.g., an AC wall outlet. In one embodiment, an AC/DC adaptor may be provided to convert between AC and DC voltage. In another embodiment, the power source includes a removable and/or rechargeable battery, and the electrical conductor 20 includes an electrical interface that interfaces with the battery. The input power to clipper 10 may range from about 100V AC-240V AC at 50 or 60 Hz, or DC voltage of 3.6V-8.4V. An indicator 22, such as an LED light, indicates when the grooming apparatus 10's motor 202 is activated. The indicator may be visual, audio, and/or tactile.

FIG. 2 shows the electrical and electromechanical components disposed within housing 12, including motor 202 and PCBA 204. PCBA 204 interfaces with electrical conductor 20, receives a power signal from the power source, modifies the power signal, and controls the motor 202 with the modified power signal. Motor 202 includes a pivot head 206 that is partially disposed within bracket 208. Other components of motor 202 disposed within the bracket 208 include bobbin 210, “E” shaped lamination 212, laminations 214, and magnet 216. In the present exemplary embodiment, the bracket 208 is formed of aluminum and magnet 216 is a rare earth magnet.

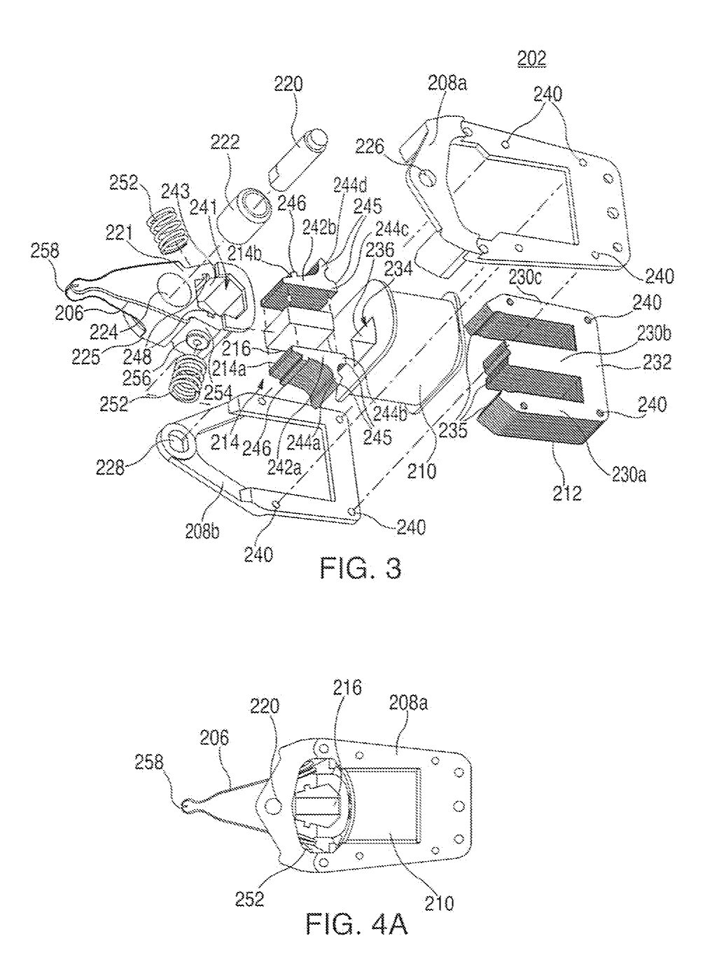

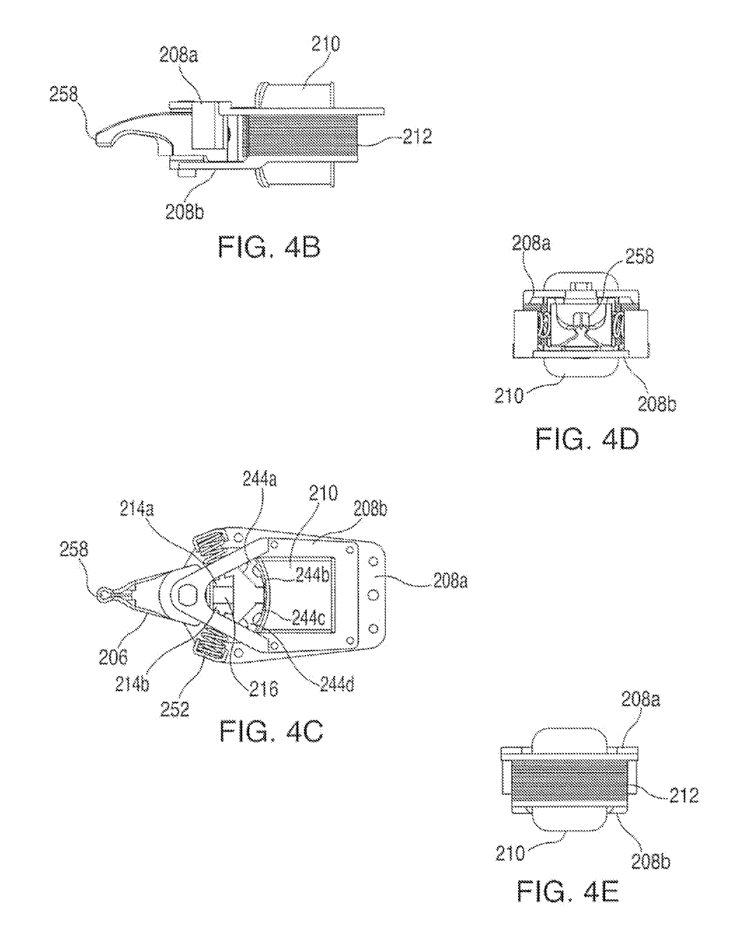

With reference to FIGS. 3 and 4, bracket 208 may include an upper bracket 208a and a lower bracket 208b which are assembled together in order to hold the pivot head 206, bobbin 210, “E” shaped lamination 212, laminations 214, and magnet 216. Pivot head 206 is provided with an aperture 224 that communicates between a top wall 221 and a bottom wall 223 of pivot head 206. Pivot pole 220 is inserted into bushing 222 which together are inserted through aperture 224 and received within apertures 226 and 228 of upper and lower brackets 208a and 208b for mounting therebetween. Pivot head 206 is thus mounted between the upper and lower brackets 208a and 208b and can pivot about the assembled pivot pole 220 and bushing 222.

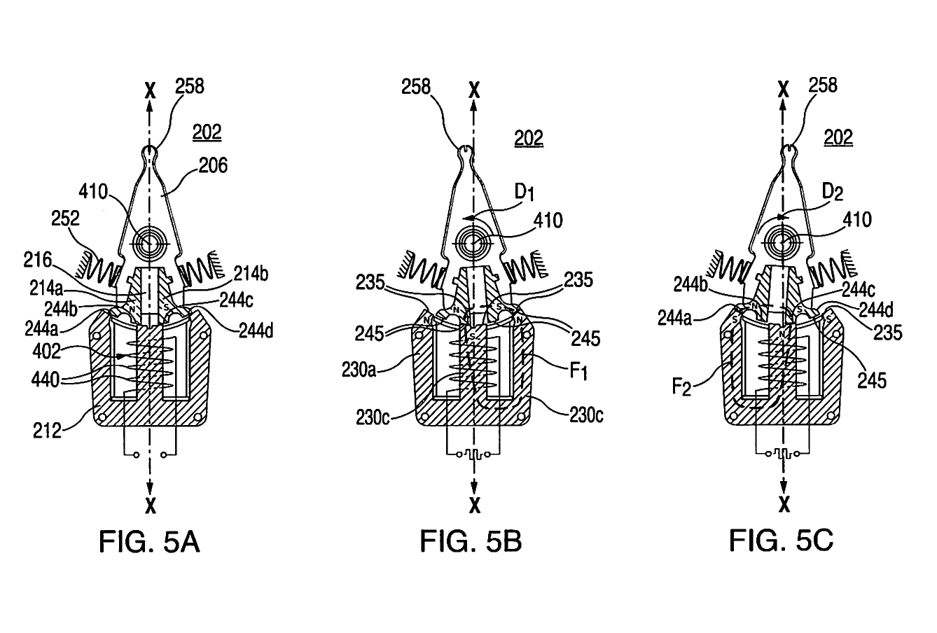

“E” shaped lamination 212 is mounted between the upper and lower brackets 208a and 208b when assembled. Bearing holes 240 are provided in the “E” shaped lamination and the upper and lower brackets 208a and 208b for assembly thereof. Other means and methods for assembling the “E” shaped lamination and the upper and lower brackets 209a and 208b are contemplated, such as epoxy, dovetailing, snap-fit, etc. “E” shaped lamination 212 includes three arms 230a-230c that extend from a base 232, each having a distal end 235. When assembled, the middle arm 230b is received within an aperture 234 that extends longitudinally through bobbin 210. Bobbin 210 is provided with a conductive coil 402 (see FIG. 5) having at least one turn that is coiled around middle arm 230b. The bobbin 210 is provided along an interior wall 236 that defines aperture 234. In the present example, the coil 402 is formed of copper.

Lamination 214 includes first and second discrete laminations 214a and 214b that are mounted within channel 241 which communicates between upper wall 221 and lower wall 223 of pivot head 206. Laminations 214a and 214b have respective arms 242a and 242b. Arm 242a is bifurcated into first and second branches 244a and 244b, each having a proximal end 245. Arm 242b is bifurcated into first and second branches 244c and 244d, each having a proximal end 245. Arms 242a and 242b are provided with a flange 246 that is received with a corresponding indentation 248 provided in an interior wall 243 of channel 241 for holding laminations 214a and 214b within channel 241. Other means and methods for mounting laminations 214a and 214b within channel 241 are contemplated.

Magnet 216 is mounted within channel 241 and between laminations 214a and 214b. Magnet 216 may be held in place by magnetic force, or alternatively additional mounting means may be provided for mounting magnet 216 in position. Balancing springs 252 are mounted between an interior of housing 12 and a side face 254 of pivot head 206 to bias pivot head 206 to a neutral position in which a distal end 258 of pivot head 206 is aligned with longitudinal axis X-X. A nub 256 may be provided on side face 254 to brace balancing spring 252 in position.

Operation of the motor 202 is shown in FIGS. 5A-5C. FIG. 5A shows motor 202 at rest in a neutral position, e.g., when the activator 18 is in an “Off” position and a current signal is not provided to coil 402. Distal end 258 of pivot head 206 is aligned with longitudinal axis X-X. Magnet 216 is polarized and induces opposite polarizations in first and second laminations 214a and 214b. In the current example first lamination 214a has polarization N and second lamination 214b has polarization S.

FIGS. 5B and 5C show motor 202 in a pivoted position in first pivot direction P1 and second pivot direction P2, respectively, while a pulse width modulated (PWM) signal is applied to the coil 402 via terminal 406. The PWM signal is provided by electrical circuit 202 as MOTOR+ and MOTOR− and alternates between a first current direction, shown in FIG. 5B and a second current direction opposite the first current direction shown in FIG. 5C. Depending on which direction the current is flowing in, a magnetic field is generated that affects the polarity of the three arms, 230a-230c. This causes forces in which the first and second arms 214a and 214b are either repelled by or attracted to the three arms 230a-230c. These forces cause the pivot head to pivot in direction P1 or P2, depending on the direction of the current applied to the coil 402.

When the current flows in the first current direction a first magnetic field F1 is induced in lamination 212 which circulates through second lamination 214b and magnet 216. The relative polarizations between laminations 212 and 214b cause distal end 245 of branch 244a which is polarized N to repel distal end 235 of first arm 230a which is also polarized N. Further, distal end 245 of branch 244b which is polarized N is attracted to distal end 235 of middle arm 230b which is polarized S. Additionally, distal end 245 of branch 244d which is polarized S is attracted to distal end 235 of third arm 230c which is also polarized N. The forces that attract and repel cause pivot head 206 to pivot about pivot point 410 in first pivot direction D1.

When the current flows in the second current direction a second magnetic field F2 is induced in lamination 212 which circulates through first lamination 214a and magnet 216. The relative polarizations between laminations 212 and 214a cause distal end 245 of branch 244d which is polarized S to repel distal end 235 of third arm 230c which is also polarized S. Further, distal end 245 of branch 244c which is polarized S is attracted to distal end 235 of middle arm 230b which is polarized N. Additionally, distal end 245 of branch 244a which is polarized N is attracted to distal end 235 of first arm 230a which is also polarized S. The forces that attract and repel cause pivot head 206 to pivot about pivot point 410 in second pivot direction D1. Thus, the PWM signal provided to the motor 202 causes the pivot head 206 to oscillate by alternately pivoting back and forth in the first and second pivot directions at a speed that is determined by the frequency of the PWM signal.

Balancing springs 252 provided on either side of pivot head 206 exert opposing biasing forces for moving pivot head 206 to the neutral rest position. When the current direction changes, the biasing force on one side is overcome, whereas the biasing force on the other side pushes pivot head 206 to pivot in the same direction as the forces induced by the newly developed magnetic field.

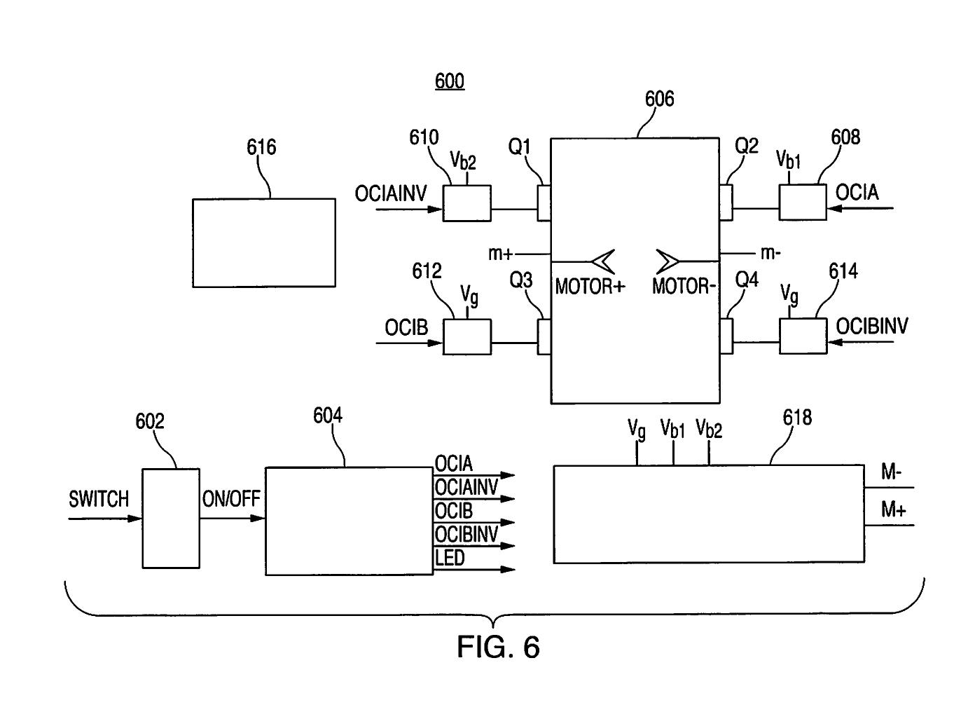

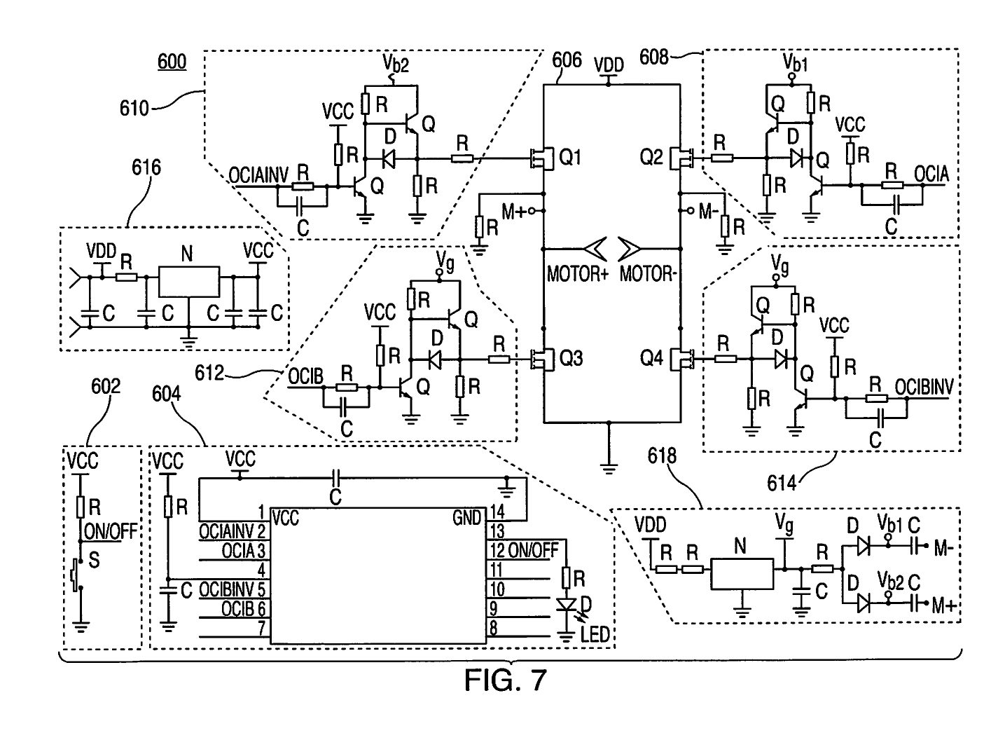

FIGS. 6-7 show exemplary electrical circuit 600 that generates MOTOR+ and MOTOR−, which is the PWM signal that is input to motor 202. Electrical circuit 600 includes a variety of electrical components, including resistors R, capacitors C, diodes D, transistors or MOSFETS Q, and other components N. Switch circuit 602 receives SWITCH signal from activator 18 and outputs ON/OFF signal which is provided to microcontroller 604. Microcontroller 604 outputs LED signal that drives indicator 22 to indicate when power is provided to the motor 202. Microcontroller 602 further outputs signals OCIA, OCIAINV (OCIA inverted), OCIB, OCIBINV (OCIB inverted) which are provided to controller 606 after having been conditioned by signal conditioning circuits 608, 610, 612, and 614, respectively. Controller 606 includes a MOSFET bridge circuit, including MOSFETs Q1, Q2, Q3, and Q4, which outputs the PWM signal, MOTOR+ and MOTOR−. The input voltage is conditioned by input conditioning circuit 616. Circuit 618 generates M− and M+ which are provided to controller 606. FIG. 7 shows circuit 600 in greater detail; however circuit 600 is not limited to the components and connections between components shown.

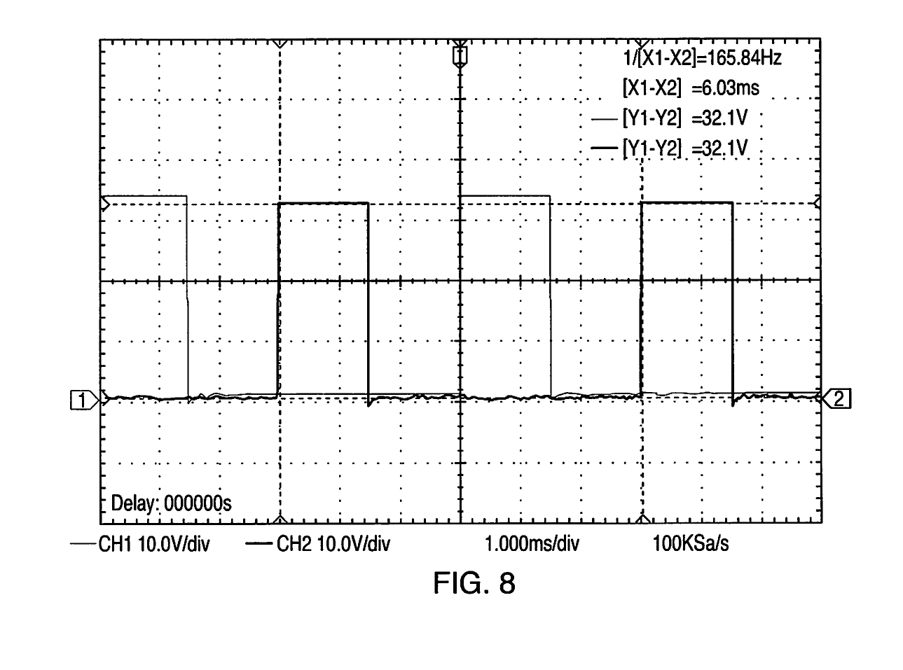

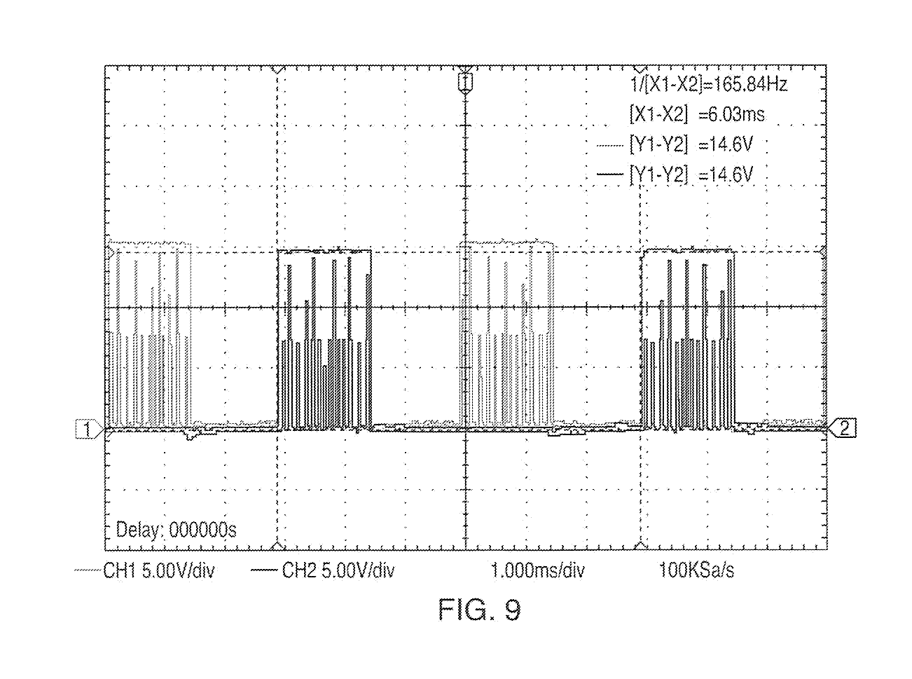

FIGS. 8 and 9 show exemplary measured output signals from MOSFETs Q1 and Q3, respectively. With reference to FIG. 8, the pulse width of the signal (X1-X2, i.e., two pulses) is 6.03 ms, the frequency is 165.84 MHz and the peak-to-peak amplitude is 32.1V. This signal is the driving signal to motor 202. With reference to FIG. 9, the pulse width (X1-X2) of the signal is 6.03 ms, the frequency is 165.84 MHz and the peak-to-peak amplitude is 14.6V. This signal is a high frequency PWM signal whose purpose is to reduce power dissipation.

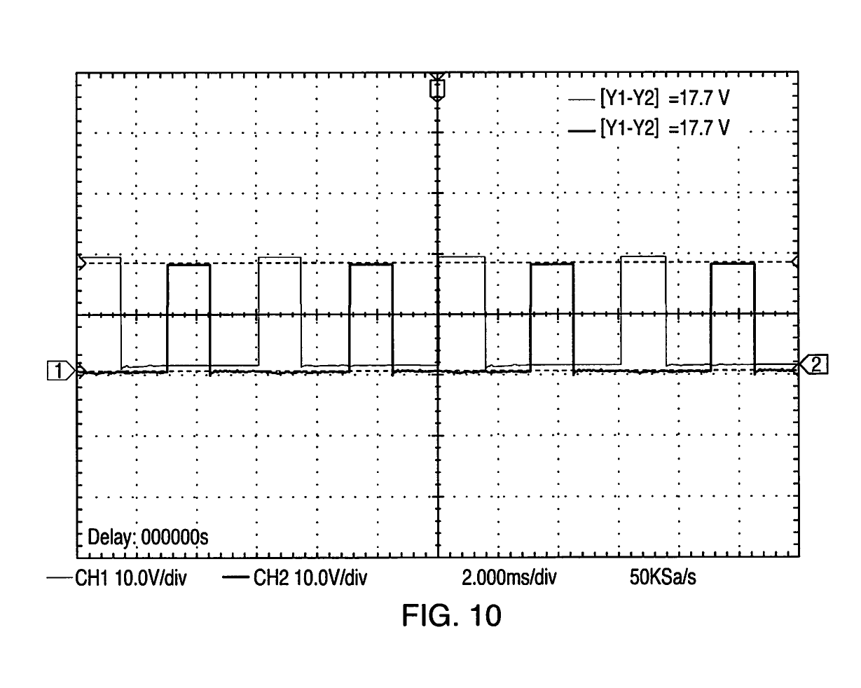

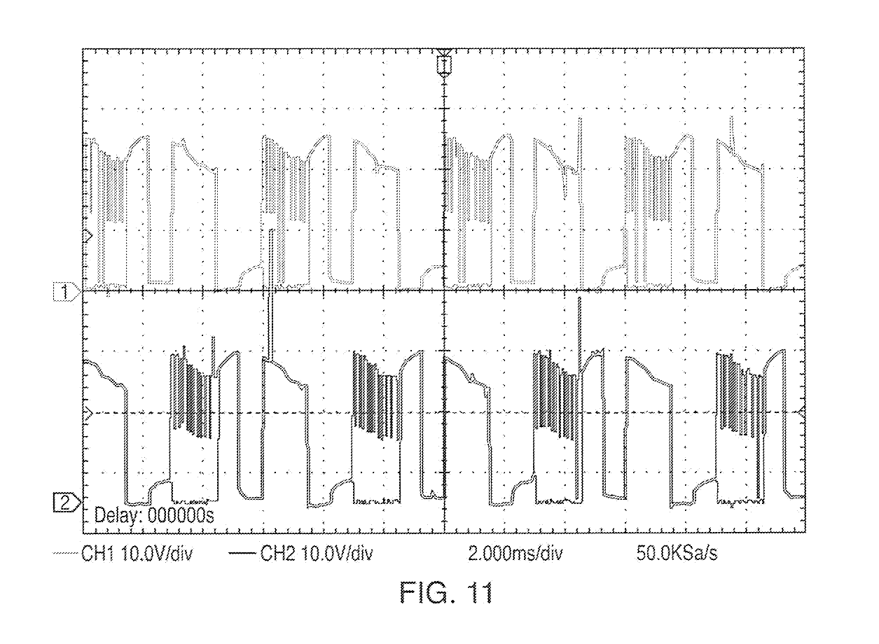

FIG. 10 is an exemplary output signal provided to motor 202 measured while the motor 202 is not connected to circuit 600. The pulse width of the double pulse signal is about 6.0 ms, the frequency is about 167 MHz, and the peak-to-peak amplitude is about 17.7V. FIG. 11 is an exemplary output signal provided to motor 202 measured while the motor 202 is connected to circuit 600. In other embodiments the frequency of the PWM signal may range between 125 Hz-200 Hz.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A motor for providing reciprocating motion comprising:
a pivotal portion pivotable about a rotation axis and having a permanent magnet mounted thereto, and first and second lamination arms each having a proximal end, wherein the magnet induces positive and negative polarities in the first and second lamination arms, respectively;
a fixed portion including an “E” shaped lamination having third, fourth, and fifth lamination arms each having a distal end, wherein the proximal ends of the first and second lamination arms proximately face at least one of the distal ends of the third, fourth and fifth lamination arms; and
a coil having at least one turn wound about the fifth lamination arm;
wherein when a current flowing in a first direction is applied to the coil, a first magnetic field is induced that affects polarity of at least one of the third, fourth and fifth lamination arms and thus generates a force that causes the first portion to pivot in a first direction, and when a current flowing in a second direction opposite to the first direction is applied to the coil, a second magnetic field is induced that affects polarity of at least one of the third, fourth and fifth lamination arms and thus generates a different force that causes the first portion to pivot in a second direction.

2. The motor in accordance with claim 1, wherein the fifth lamination is positioned in between the third and fourth lamination arms, and the first magnetic field causes the third and fourth lamination arms to have a positive polarity and the fifth lamination arm to have a negative polarity, and the second magnetic field causes the third and fourth lamination arms to have a negative polarity and the fifth lamination arm to have a positive polarity.

3. The motor in accordance with claim 2, wherein:
the first lamination arm has a first and second branch and the second lamination arm has a third and fourth branch;
when the current flows in the first direction, the first branch and the third arm repel one another and the fourth branch and fifth arm are attracted to one another; and
when the current flows in the second direction, the fourth branch and fifth arm repel one another and the first branch and third arm are attracted to one another.

4. The motor in accordance with claim 3, wherein:
when the current flows in the first direction, the second branch and the fourth arm are attracted to one another and the third branch and fourth arm repel one another; and
when the current flows in the second direction, the third branch and fifth arm are attracted to one another and the second branch and fourth arm repel one another.

5. The motor in accordance with claim 1, wherein a current flowing in alternating directions is applied to the coil, causing the first portion to alternate between pivoting in the direction and the second direction.

6. The motor in accordance with claim 1, wherein the first and second laminations are discrete from one another.

7. The motor in accordance with claim 1, wherein the permanent magnet is spaced from the second portion.

8. The motor in accordance with claim 1, wherein the current applied to the coil is a pulse width modulated (PWM) signal.

9. The motor in accordance with claim 8, further comprising a circuit for generating the PWM signal, wherein the frequency of the PWM signal ranges between 125 Hz-200 Hz.

10. The motor in accordance with claim 8, further comprising a circuit for generating the PWM signal, wherein the frequency of the PWM signal exceeds 160 Hz.

11. The motor in accordance with claim 1, wherein the motor drives operation of a hair grooming device selected from the group of hair grooming devices including a trimmer, a shaver, and a clipper.

12. A circuit for driving a motor for providing an oscillating motion of a pivot head in a hair grooming device, the circuit comprising a controller for controlling the circuit to output a PWM signal having a frequency that ranges between 125 Hz-200 Hz.

13. The circuit for driving the motor in accordance with claim 12, wherein the frequency of the PWM signal exceeds 160 Hz.

14. The circuit for driving the motor in accordance with claim 12, further comprising a controller having four MOSFETs.

15. The circuit for driving the motor in accordance with claim 12, wherein the controller receives a first and second input signals and third and fourth signals that are respective inverted versions of the first and second input signals.
